(19) United States
(12) Patent Application Publication
(10) Pub. No.: US 2026/0253099 A1
(43) Pub. Date: Aug. 27, 2026

(54) SYSTEM AND METHOD FOR IDENTIFYING DORMANT ACCOUNT

(71) Applicant: Truist Bank, Charlotte, NC (US)

(72) Inventors: Himanshu Johri, Charlotte, NC (US); Rajendra Prasad Molakalapalli, Charlotte, NC (US); Abhay Vijay Mone, Charlotte, NC (US); Keyur Prakash Dave, Charlotte, NC (US)

(73) Assignee: Truist Bank, Charlotte, NC (US)

(21) Appl. No.: 19/065,986

(22) Filed: Feb. 27, 2025

(51) Int. Cl. G06Q 30/0207

(52) U.S. Cl. CPC G06Q 30/0224; G06Q 30/0239

(57) ABSTRACT

A system includes: a display; a memory having stored therein, customer purchase history data associated with a customer, a purchase threshold PTH, promotion data relating to an available promotion, and executable instructions stored therein; and a processor configured to execute the executable instructions to cause the system to: classify the customer as an active customer when a feature of the customer purchase history data is equal to or greater than the purchase threshold PTH; classify the customer as a dormant customer when the feature of the customer purchase history data is less than the purchase threshold PTH; generate an available promotion signal based on the promotion data; and transmit the available promotion signal to the display to cause the display to display information related to the available promotion.

### TECHNICAL FIELD

Aspects of the present disclosure are generally related to systems and computer-implemented methods of classifying customers of an enterprise.

### BACKGROUND

With respect to enterprises that extend credit to customers via a credit card, different customers use the respective extended credit in different manners. If a customer does not expend his allotted credit, then the non-expended credit is not providing income to the enterprise. It is in the enterprise's best interest to maximize income. For this reason, it may be beneficial to reallocate non-expended credit, in cases where a customer is not likely to eventually use the non-expended credit.

What is needed is a system and method to identify customers that are not likely to use non-expended credit.

### SUMMARY

An aspect of the present disclosure is drawn to a system that includes: a display; a memory having stored therein, customer purchase history data associated with a customer, a purchase threshold P_{TH}, promotion data relating to an available promotion, and executable instructions stored therein; and a processor configured to execute the executable instructions to cause the system to: classify the customer as an active customer when a feature of the customer purchase history data is equal to or greater than the purchase threshold P_{TH}; classify the customer as a dormant customer when the feature of the customer purchase history data is less than the purchase threshold P_{TH}; generate an available promotion signal based on the promotion data; and transmit the available promotion signal to the display to cause the display to display information related to the available promotion.

In one or more embodiments of this aspect, the processor is further configured to execute the executable instructions to additionally cause the system to: identify a customer engagement event within the customer purchase history data associated with a maximum gradient change when the feature of the customer purchase history data is less than the purchase threshold P_{TH}; identify a customer engagement event date associated with the customer engagement event; and store, into the memory, customer engagement event data associated with the customer engagement event, wherein the customer engagement event data includes the customer engagement event date. In one or more of these embodiments, the memory additionally has stored therein, customer engagement event questioning data relating to a predetermined question regarding the customer engagement event, and the processor is further configured to execute the executable instructions to additionally cause the system to: generate a predetermined question signal based on the customer engagement event questioning data and the customer engagement event data; and transmit the predetermined question signal to the display to cause the display to display information related to the predetermined question regarding the customer engagement event.

In one or more embodiments of this aspect, the memory additionally has stored therein, a time threshold T_{TH} and customer time data associated with a time period of the customer, and the processor is further configured to execute the executable instructions to additionally cause the system to classify the customer as a viable customer when the time period of the customer is equal to or greater than the time threshold T_{TH}, classify the customer as a non-viable customer when the time period of the customer is less than the time threshold T_{TH}, classify the customer as an active customer when a feature of the customer purchase history data is equal to or greater than the purchase threshold P_{TH}, and the customer is classified as a viable customer, and classify the customer as a dormant customer when the feature of the customer purchase history data is less than the purchase threshold P_{TH}, and the customer is classified as a viable customer.

In one or more embodiments of this aspect, the purchase threshold P_{TH} is generated via a machine learning algorithm based on purchase history data of a plurality of customers. In one or more of these embodiments, the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.

In one or more embodiments of this aspect, the memory additionally has stored therein, customer contact information relating to one of a phone number associated with the customer, an email address associated with the customer, and combinations thereof, and the processor is further configured to execute the executable instructions to additionally cause the system to: generate a customer contact information signal based on the customer contact information; and transmit the customer contact information signal to the display to cause the display to display information related to the customer contact information.

Another aspect of the present disclosure is drawn to a computer-implemented method of operating a system. The computer-implemented method includes: classifying, via a processor configured to execute executable instructions stored within a memory additionally having stored therein, customer purchase history data associated with a customer, and a purchase threshold P_{TH}, promotion data relating to an available promotion, the customer as an active customer when a feature of the customer purchase history data is equal to or greater than the purchase threshold P_{TH}; classifying, via the processor, the customer as a dormant customer when the feature of the customer purchase history data is less than the purchase threshold P_{TH}, generating, via the processor, an available promotion signal based on the promotion data; and transmitting, via the processor and to a display, the available promotion signal to cause the display to display information related to the available promotion.

In one or more embodiments of this aspect, the computer-implemented method further includes: identifying, via the processor, a customer engagement event within the customer purchase history data associated with a maximum gradient change when the feature of the customer purchase history data is less than the purchase threshold P_{TH}; identifying, via the processor, a customer engagement event date associated with the customer engagement event; and storing, into the memory, customer engagement event data associated with the customer engagement event, wherein the customer engagement event data includes the customer engagement event date. In one or more of these embodiments, the memory additionally has stored therein, customer engagement event questioning data relating to a predetermined question regarding the customer engagement event, and the computer-implemented method further includes: generating, via the processor, a predetermined question signal based on the customer engagement event questioning data and the customer engagement event data; and transmitting, via the processor and to the display, the predetermined question signal to cause the display to display information related to the predetermined question regarding the customer engagement event.

In one or more embodiments of this aspect, the memory additionally has stored therein, a time threshold T_{TH} and customer time data associated with a time period of the customer, and the computer-implemented method further includes: classifying, via the processor, the customer as a viable customer when the time period of the customer is equal to or greater than the time threshold T_{TH}; classifying, via the processor, the customer as a non-viable customer when the time period of the customer is less than the time threshold T_{TH}; classifying, via the processor, the customer as an active customer when a feature of the customer purchase history data is equal to or greater than the purchase threshold P_{TH}, and the customer is classified as a viable customer; and classifying, via the processor, the customer as a dormant customer when the feature of the customer purchase history data is less than the purchase threshold P_{TH}, and the customer is classified as a viable customer.

In one or more embodiments of this aspect, the purchase threshold P_{TH} is generated via a machine learning algorithm based on purchase history data of a plurality of customers. In one or more of these embodiments, the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.

In one or more embodiments of this aspect, the memory additionally has stored therein, customer contact information relating to one of a phone number associated with the customer, an email address associated with the customer, and combinations thereof, and the computer-implemented method further includes: generating, via the processor, a customer contact information signal based on the customer contact information; and transmitting, via the processor and to the display, the customer contact information signal to cause the display to display information related to the customer contact information.

Another aspect of the present disclosure is drawn to a non-transitory, computer-readable media having computer-readable instructions stored thereon, wherein the computer-readable instructions are capable of being read by system, and wherein the computer-readable instructions are capable of instructing the system to perform a computer-implemented method including: classifying, via a processor configured to execute executable instructions stored within a memory additionally having stored therein, customer purchase history data associated with a customer, and a purchase threshold P_{TH}, promotion data relating to an available promotion, the customer as an active customer when a feature of the customer purchase history data is equal to or greater than the purchase threshold P_{TH}, classifying, via the processor, the customer as a dormant customer when the feature of the customer purchase history data is less than the purchase threshold P_{TH}; generating, via the processor, an available promotion signal based on the promotion data; and transmitting, via the processor and to a display, the available promotion signal to cause the display to display information related to the available promotion.

In one or more embodiments of this aspect, the computer-readable instructions are capable of instructing the system to perform the computer-implemented method further including: identifying, via the processor, a customer engagement event within the customer purchase history data associated with a maximum gradient change when the feature of the customer purchase history data is less than the purchase threshold P_{TH}; identifying, via the processor, a customer engagement event date associated with the customer engagement event; and storing, into the memory, customer engagement event data associated with the customer engagement event, wherein the customer engagement event data includes the customer engagement event date. In one or more of these embodiments, the memory additionally has stored therein, customer engagement event questioning data relating to a predetermined question regarding the customer engagement event, and the computer-readable instructions are capable of instructing the system to perform the computer-implemented method further including: generating, via the processor, a predetermined question signal based on the customer engagement event questioning data and the customer engagement event data; and transmitting, via the processor and to the display, the predetermined question signal to cause the display to display information related to the predetermined question regarding the customer engagement event.

In one or more embodiments of this aspect, the memory additionally has stored therein, a time threshold T_{TH} and customer time data associated with a time period of the customer, and the computer-readable instructions are capable of instructing the system to perform the computer-implemented method further including: classifying, via the processor, the customer as a viable customer when the time period of the customer is equal to or greater than the time threshold T_{TH}; classifying, via the processor, the customer as a non-viable customer when the time period of the customer is less than the time threshold T_{TH}; classifying, via the processor, the customer as an active customer when a feature of the customer purchase history data is equal to or greater than the purchase threshold P_{TH}, and the customer is classified as a viable customer; and classifying, via the processor, the customer as a dormant customer when the feature of the customer purchase history data is less than the purchase threshold P_{TH}, and the customer is classified as a viable customer.

In one or more embodiments of this aspect, the purchase threshold PTH is generated via a machine learning algorithm based on purchase history data of a plurality of customers. In one or more of these embodiments, the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the client device of FIG. 1.

FIG. 3 illustrates a block diagram of the one or more enterprise servers of FIG. 1.

FIG. 4 illustrates a block diagram of the data stores of the one or more enterprise servers of FIG. 3.

FIG. 5 illustrates an example computer-implemented method of converting dormant customers to active customers in accordance with aspects of the present disclosure.

FIG. 6 illustrates a block diagram of an example enterprise having the one or more enterprise servers of FIG. 1.

FIG. 7 illustrates a block diagram of an example enterprise user device of the enterprise of FIG. 6.

FIG. 8 illustrates a block diagram of a portion of one or more enterprise servers of FIG. 3 for classifying a customer as viable or non-viable in accordance with aspects of the present disclosure.

FIG. 9A illustrates a block diagram of a portion of one or more enterprise servers of FIG. 3 for determining a purchase threshold P_{TH} at a time t₀ in accordance with aspects of the present disclosure.

FIG. 9B illustrates the block diagram of FIG. 9A at a time t₁ in accordance with aspects of the present disclosure.

FIG. 10A illustrates a graph of example customer purchase history for an example customer up to the present.

FIG. 10B illustrates a graph of example customer purchase history for another example customer up to the present.

FIG. 10C illustrates a graph of example customer purchase history for yet another example customer up to the present.

FIGS. 11A through 11C respectively illustrate a block diagram of a portion of one or more enterprise servers of FIG. 3 for classifying a customer as active or dormant in accordance with aspects of the present disclosure.

FIG. 12 illustrates a discrete plot of interactions of an example customer up to the present.

FIG. 13 illustrates a block diagram of a portion of one or more enterprise servers of FIG. 3 and the enterprise user device of FIG. 6 for displaying information related to a predetermined question regarding an engagement event in accordance with aspects of the present disclosure.

FIG. 14 illustrates a user interface of the enterprise user device of FIG. 7 displaying a predetermined question regarding an engagement event in accordance with aspects of the present disclosure.

FIG. 15 illustrates the promotions data storage displaying available promotions in accordance with aspects of the present disclosure.

FIG. 16 illustrates a block diagram of a portion of one or more enterprise servers of FIG. 3 and the enterprise user device of FIG. 6 for displaying information related to an available promotion in accordance with aspects of the present disclosure.

FIG. 17 illustrates a user interface of the enterprise user device of FIG. 7 displaying a predetermined available promotion in accordance with aspects of the present disclosure.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to customer engagement events or actions that can be caused, triggered, or otherwise occur without human intervention.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module includes a general-purpose processor configured by software to become a special-purpose processor, the general-purpose processor may be configured as respectively different special-purpose processors (e.g., including different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a computer-implemented method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within an enterprise application.

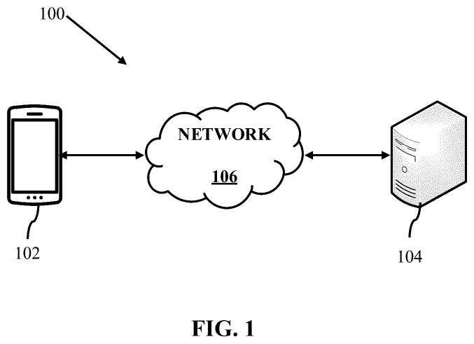

Turning to the figures, in which FIG. 1 illustrates a communication environment 100 in which a user communicates with an enterprise. A client device 102 operating in communication environment 100 facilitates user access to and user management of one or more user accounts residing at one or more enterprise servers 104 of the enterprise. Communication environment 100 includes client device 102, one or more enterprise servers 104, and a communications network 106 through which communication is facilitated between client device 102 and one or more enterprise servers 104.

In accordance with one or more embodiments, client device 102 may take the form of a computing device, non-limiting examples of which include a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates client device 102 including any form of electronic device that optimizes the performance and functionality of the one or more embodiments in a manner that falls within the spirit and scope of the principles of this disclosure.

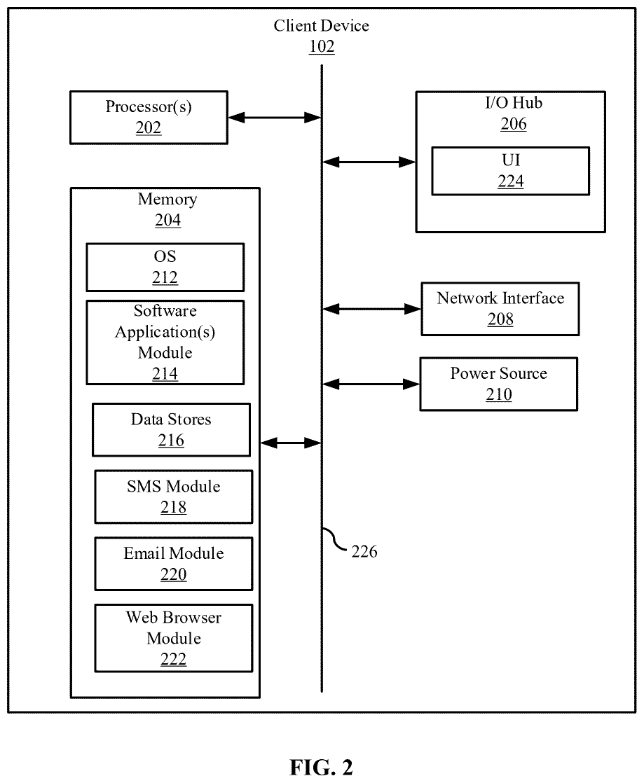

FIG. 2 illustrates a block diagram of client device 102. It will be understood that it is not necessary for client device 102 to have all the elements illustrated in FIG. 2. For example, client device 102 may have any combination of the various elements illustrated in FIG. 2. Moreover, client device 102 may have additional elements to those illustrated in FIG. 2.

As shown in the figure, client device 102 includes one or more processors 202, a non-transitory memory 204 operatively coupled to one or more processors 202, an input/output (I/O) hub 206, a network interface 208, a power source 210, and a communication bus 226.

In this example, one or more processors 202, non-transitory memory 204, I/O hub 206, network interface 208, and power source 210 are illustrated as individual elements of client device 102. However, in one or more embodiments, at least two of one or more processors 202, non-transitory memory 204, I/O hub 206, network interface 208, and power source 210 may be combined as a unitary device. Further, in one or more embodiments, at least one of one or more processors 202, non-transitory memory 204, I/O hub 206, and network interface 208 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to client device 102 such that the processor may read information from and write information to the tangible computer-readable media. In the alternative, the tangible computer-readable media may be integral to client device 102. The tangible computer-readable media may reside in an integrated circuit (IC), an ASIC, or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

In the figure, one or more processors 202, non-transitory memory 204, I/O hub 206, network interface 208, and power source 210 are configured to communicate with one another via communication bus 226.

Memory 204 includes a set of instructions of computer-executable program code, an operating system 212, a software application module 214, one or more data stores 216, a short message service (SMS) module 218, an email module 220, and a web browser module 222.

In this example, operating system 212, software application module 214, one or more data stores 216, SMS module 218, email module 220, and web browser module 222 are illustrated as individual elements of memory 204. However, in one or more embodiments, at least two of operating system 212, software application module 214, one or more data stores 216, SMS module 218, email module 220, and web browser module 222 may be combined as a unitary element.

The set of instructions within memory 204 are executable by one or more processors 202 to cause one or more processors 202 to execute operating system 212 and one or more software applications of software application module 214 that reside in memory 204. The one or more software applications residing in memory 204 includes, but is not limited to, an enterprise application that is associated with enterprise servers 104 and which facilitates user access to the one or more user accounts in addition to user management of the one or more user accounts. The enterprise application includes a mobile enterprise application that facilitates establishment of a secure connection between client device 102 and one or more enterprise servers 104.

One or more data stores 216 are operable to store one or more types of data. Client device 102 may include one or more interfaces that facilitate one or more systems or modules thereof to transform, manage, retrieve, modify, add, or delete, the data residing in one or more data stores 216. One or more data stores 216 may include volatile and/or non-volatile memory. Examples of suitable data stores 216 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 216 may be a component of one or more processors 202, or alternatively, may be operatively connected to one or more processors 202 for use thereby. As set forth, described, and/or illustrated herein, “operatively connected” may include direct or indirect connections, including connections without direct physical contact.

SMS module 218 is operable to facilitate user transmission and receipt of text messages via client device 102 though network 106. In one example embodiment, a user may receive text messages from the enterprise that are associated with the user access and the user management of the one or more user accounts.

Email module 220 is operable to facilitate user transmission and receipt of email messages via client device 102 through network 106. In one example embodiment, a user may receive email messages from the enterprise that are associated with the user access and the user management of the one or more user accounts.

Web browser module 222 is operable to facilitate user access to one or more websites associated with the enterprise through network 106.

I/O hub 206 is operable to connect to other systems and subsystems of client device 102. I/O hub 206 may include one or more of an input interface, an output interface, and a network controller to facilitate communications between client device 102 and one or more enterprise servers 104. The input interface and the output interface may be integrated as a single, unitary user interface 224, or alternatively, be separate as independent interfaces that are operatively connected.

As used herein, the input interface is defined as any device, software, component, system, element, or arrangement or groups thereof that enable information and/or data to be entered as input commands by a user in a manner that directs one or more processors 202 to execute instructions. The input interface may include a user interface (UI), a graphical user interface (GUI), such as, for example, a display, human-machine interface (HMI), or the like. Embodiments, however, are not limited thereto, and thus, this disclosure contemplates the input interface including a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may include one or more of a visual display or an audio display, including, but not limited to, a microphone, earphone, and/or speaker. One or more components of client device 102 may serve as both a component of the input interface and a component of the output interface.

Network interface 208 is operable to facilitate connection to network 106.

Power source 210 includes at least one of a wired powered source, a wireless power source, a replaceable battery source, a rechargeable battery source, and combinations thereof.

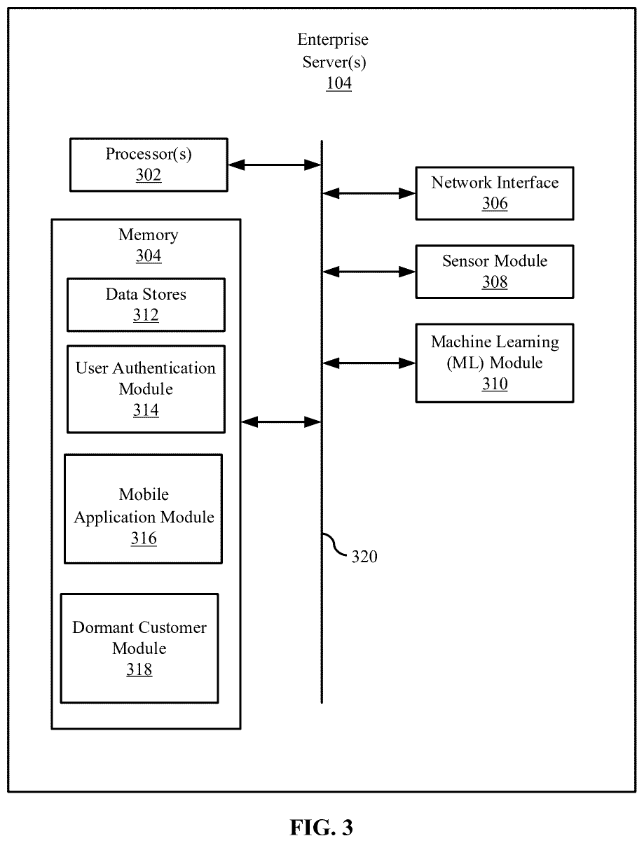

FIG. 3 illustrates a block diagram of one or more enterprise servers 104. It will be understood that it is not necessary for each server in one or more enterprise servers 104 to have all the elements illustrated in FIG. 3. For example, each server in one or more enterprise servers 104 may have any combination of the various elements illustrated in FIG. 3. Moreover, each server in one or more enterprise servers 104 may have additional elements to those illustrated in FIG. 3.

As illustrated in FIG. 3, one or more enterprise servers 104 includes one or more processors 302, a non-transitory memory 304 operatively coupled to one or more processors 302, a network interface 306, a sensor module 308, a machine learning (ML) module 310, and a communication bus 318.

In this example, one or more processors 302, non-transitory memory 304, network interface 306, sensor module 308, and ML module 310 are illustrated as individual elements of one or more enterprise servers 104. However, in one or more embodiments, at least two of one or more processors 302, non-transitory memory 304, network interface 306, sensor module 308, and ML module 310 may be combined as a unitary device. Further, in one or more embodiments, at least one of one or more processors 302, non-transitory memory 304, network interface 306, sensor module 308, and ML module 310 may be implemented as a computer having non-transitory computer-readable media for carrying or having computer-executable instructions or data structures stored thereon.

In the figure, one or more processors 302, non-transitory memory 304, network interface 306, sensor module 308, and ML module 310 are configured to communicate with one another via communication bus 226.

Memory 304 includes a set of instructions of computer-executable program code, one or more data stores 312, a user authentication module 218, and a mobile enterprise application module 316.

In this example, one or more data stores 312, a user authentication module 218, and a mobile enterprise application module 316 are illustrated as individual elements of memory 304. However, in one or more embodiments, at least two of one or more data stores 312, a user authentication module 218, and a mobile enterprise application module 316 may be combined as a unitary element.

The set of instructions in memory 304 are executable by one or more processors 302 in manner that facilitates control of a user authentication module 314 and a mobile enterprise application module 316 having one or more mobile enterprise applications that reside in memory 304.

One or more data stores 312 are operable to store one or more types of data, including but not limited to, user account data and user authentication data. One or more data stores 312 may include volatile and/or non-volatile memory. Examples of suitable data stores 312 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 312 may be a component of one or more processors 302, or alternatively, may be operatively connected to one or more processors 302 for use thereby. As set forth, described, and/or illustrated herein, “operatively connected” may include direct or indirect connections, including connections without direct physical contact.

The computer-executable program code may instruct one or more processors 302 to cause user authentication module 312 to authenticate a user in order to gain user access to the one or more user accounts. User authentication module 312 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile enterprise applications of mobile enterprise application module 316 may instruct one or more processors 302 to execute certain logic, data-processing, and data-storing functions of one or more enterprise servers 104, in addition to certain communication functions of one or more enterprise servers 104. The one or more mobile enterprise applications of mobile enterprise application module 316 are operable to communicate with client device 102 in a manner which facilitates user access to the one or more user accounts in addition to user management of the one or more user accounts based on successful user authentication.

In accordance with one or more embodiments set forth, described, and/or illustrated herein, network 106 may include a wireless network, a wired network, or any suitable combination thereof. For example, network 106 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

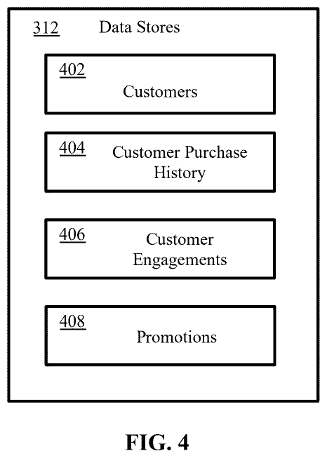

FIG. 4 illustrates a block diagram of data stores 312. As shown in the figure, data stores 312 includes a customer data storage 402, a customer purchase history data storage 404, a customer engagements data storage 406 and a promotions data storage 408.

Customer data storage 402 may be configured to store data associated with each individual customer, non-limiting examples of which include: customer name; customer address; customer phone number(s); customer email address(es); customer start date; customer payment history; customer account limit; and customer account number.

Customer purchase history data storage 404 may be configured to store data associated with purchase history for each individual customer, non-limiting examples of which include: purchase dates; purchase amounts; and purchase locations.

Customer engagements data storage 406 may be configured to store data associated with engagements with each individual customer, non-limiting examples of which include: type of engagement, non-limiting examples of which include direct enterprise customer representative initiated phone call, automated enterprise initiated phone call, direct customer initiated phone call, direct enterprise customer representative initiated email, automated enterprise initiated email, direct customer initiated email; date of each engagement; notes related to each engagement; and customer survey information related to each engagement.

Promotions data storage 408 may be configured to store data associated with promotions provided by the institution, non-limiting examples of which include: current promotions provided by the institution for active customers; current promotions provided by the institution for dormant customers; future promotions to be provided by the institution for active customers; and future promotions to be provided by the institution for dormant customers.

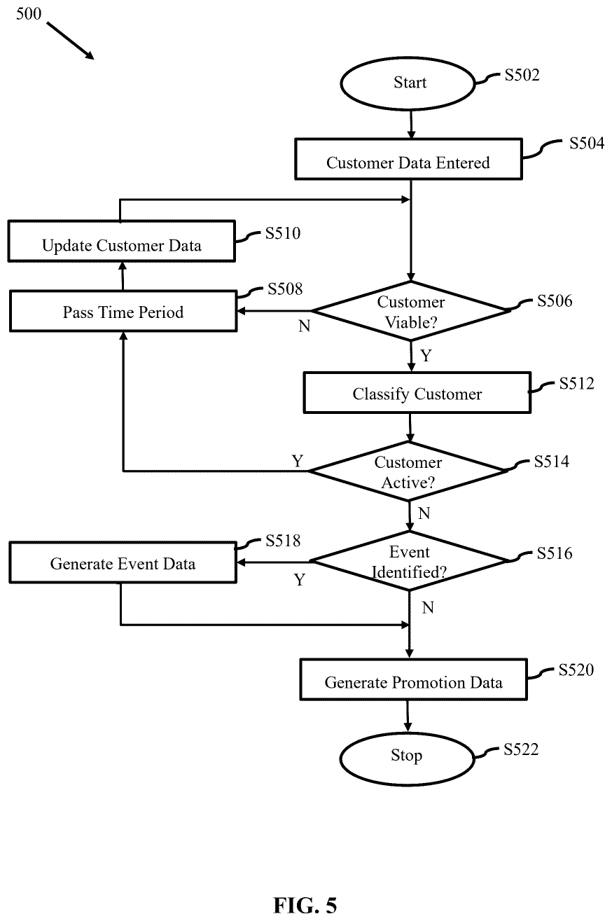

FIG. 5 illustrates an example computer-implemented method 500 of converting dormant customers to active customers in accordance with aspects of the present disclosure.

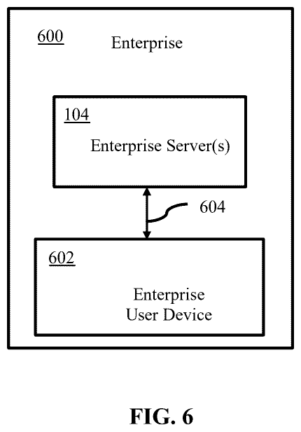

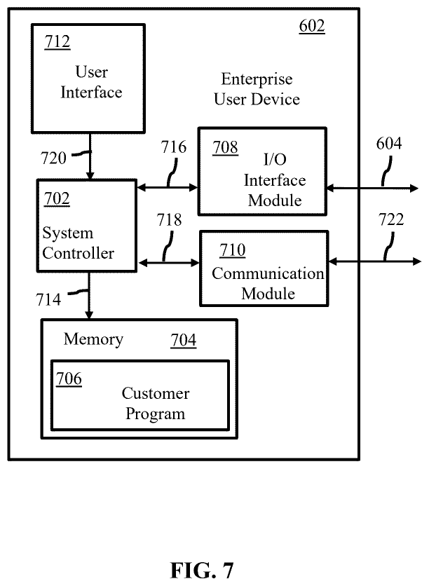

As shown in the figure, computer-implemented method 500 starts (S502) and customer data is entered (S504). For example, returning to FIG. 3, processor(302) may execute instructions in dormant customer module 318 to enter customer data into data stores 312. As shown in FIG. 4, when a customer joins the enterprise. This will be described in greater detail with reference to FIGS. 6-7.

FIG. 6 illustrates a block diagram of an example enterprise 600 having one or more enterprise servers 104. As shown in the figure, enterprise 600 includes one or more enterprise servers 104, an enterprise user device 602, and a communication channel 604.

One or more enterprise servers 104 are configured to communicate with enterprise user device 602 via communication channel 604.

Financial institution user device 602 may be any device or system that is configured to enable a user to access and interact with one or more enterprise servers 104. Non-limiting examples of enterprise user device 602 include a computer or client device.

FIG. 7 illustrates a block diagram of enterprise user device 602. As shown in the figure, enterprise user device 602 includes a system controller 702, a memory 704 having instructions and a customer program 706 stored therein, an input/output (I/O) interface module 708, a communication module 710, a user interface (UI) 712, and communication channels 714, 716, 718, and 720.

In this example, system controller 702, memory 704, I/O interface module 708, communication module 710, and UI 712 are illustrated as individual elements of one or more enterprise user device 602. However, in one or more embodiments, at least two of system controller 702, memory 704, I/O interface module 708, communication module 710, and UI 712 may be combined as a unitary device. Further, in one or more embodiments, at least one of system controller 702, memory 704, I/O interface module 708, communication module 710, and UI 712 may be implemented as a computer having non-transitory computer-readable media for carrying or having computer-executable instructions or data structures stored thereon.

System controller is configured to communicate with: memory 704 via communication channel 714; I/O interface module 708 via communication channel 716; communication module 710 via communication channel 718; and UI 712 via communication channel 712.

I/O interface module is additionally configured to communicate with one or more enterprise servers 104 via communication channel 604.

Communication module is additionally configured to communicate with client device 102 via communication channel 722 and network 106.

Each of communication channels 714, 716, 718, 720, and 722 may be any known type of communication channel, including wired and wireless.

System controller 702 may be any device or system that is configured to control general operations of enterprise user device 602 and includes, but is not limited to, a CPU, a hardware microprocessor, a single core processor, a multi-core processor, an FPGA, a microcontroller, an ASIC, a DSP, or other similar processing device capable of executing any type of instructions, algorithms, or software for controlling the operation and functions of enterprise user device 602.

Memory 704 may be any device or system capable of storing data and instructions used by enterprise user device 602 and includes, but is not limited to, RAM, DRAM, a hard drive, a solid-state drive, ROM, EPROM, EEPROM, flash memory, embedded memory blocks in an FPGA, or any other various layers of memory hierarchy.

Customer program 706 includes instructions, that when executed by system controller 702, enable enterprise user device 602 to perform the functions disclosed herein.

In one or more embodiments, as will be described in greater detail below, customer program 706 includes instructions, that when executed by system controller 702, enable enterprise user device 602 to cause UI 712 to display information related to customer contact information.

In one or more embodiments, as will be described in greater detail below, customer program 706 includes instructions, that when executed by system controller 702, enable enterprise user device 602 to cause UI 712 to display information related to an available promotion.

In one or more embodiments, as will be described in greater detail below, customer program 706 includes instructions, that when executed by system controller 702, enable enterprise user device 602 to cause UI 712 to display information related to a predetermined question regarding a customer engagement event.

I/O interface module 708 is operable to connect to one or more enterprise servers 104. I/O interface module 708 may include one or more of an input interface, an output interface, and a network controller to facilitate communications between enterprise user device 602 and one or more enterprise servers 104. The input interface and the output interface may be integrated as a single, unitary interface, or alternatively, be separate as independent interfaces that are operatively connected.

Communication module 710 may be any device or system that is operable to facilitate user communications with devices external to enterprise 600. In one or more embodiments, communication module is operable to enable transmission of text messages from enterprise user device 602 to client device 102 though network 106 via communication channel 722. In one or more embodiments, communication module 710 is operable to enable receipt of text messages from client device 102 by enterprise user device 602 though network 106 via communication channel 722. In one or more embodiments, communication module is operable to enable transmission of email messages from enterprise user device 602 to client device 102 though network 106 via communication channel 722. In one or more embodiments, communication module 710 is operable to enable receipt of email messages from client device 102 by enterprise user device 602 though network 106 via communication channel 722. In one or more embodiments, communication module is configured to facilitate user access to one or more websites through network 106.

UI 712 may be any device, software, component, system, element, or arrangement or groups thereof that enable information and/or data to be entered as input commands by a user in a manner that directs system controller 702 to execute instructions and that enable information/data to be presented to a user. UI 712 may include a user interface (UI), a graphical user interface (GUI), such as, for example, a display, human-machine interface (HMI), or the like. Embodiments, however, are not limited thereto, and thus, this disclosure contemplates UI 712 including a keypad, touch screen, multi-touch screen, button, joystick, mouse, trackball, microphone and/or combinations thereof. UI 712 may additionally include one or more of a visual display or an audio display, including, but not limited to, a microphone, earphone, and/or speaker.

In operation, when a customer joins enterprise 600 an employee (not shown) of enterprise may enter data associated with the customer into one or more enterprise servers 104. Specifically, the employee may enter data associated with the customer via user interface 712. System controller 702 will execute instructions in customer grogram 706 to cause I/O interface module 708 to store the data associated with the customer into customer data storage 402. Non-limiting examples of the types of data associated with the customer include customer name; customer address; customer phone number(s); customer email address(es); and customer start date.

In one or more embodiments, customer program 706 includes instructions, that when executed by system controller 702, cause system controller 702 to generate a customer account limit and a customer account number, and store the generated customer account limit and customer account number into customer data storage 402.

Returning to FIG. 5, after customer data is entered (S504), it is determined whether the customer is viable (S506). For example, returning to FIG. 3, one or more processors 302 may execute instructions in dormant customer module 318 to cause one or more enterprise servers 104 to determine whether the customer is viable.

In accordance with aspects of the present disclosure, a customer is viable when the period that the customer has been a customer of enterprise 600 is equal to or greater than a time threshold T_{TH}.

In one or more embodiments, the time threshold T_{TH} may be further limited to exclude customers that have breached terms of enterprise 600. For example, in one or more embodiments, a customer is viable: if the customer has been a customer of enterprise 600 for longer than a predetermined threshold of time T_{TH}; and if the customer has breached any terms of enterprise 600 for more than a predetermined threshold of time T_{BT}. In one or more embodiments, T_{TH} is equal to or greater than two years. A non-limiting type of breach of terms includes making late payments. In one or more embodiments, T_{BT} is equal to or greater than two years. In one or more embodiments, T_{TH} and T_{BT} are different threshold values. In one or more embodiments, T_{TH} and T_{BT} are the saved threshold values.

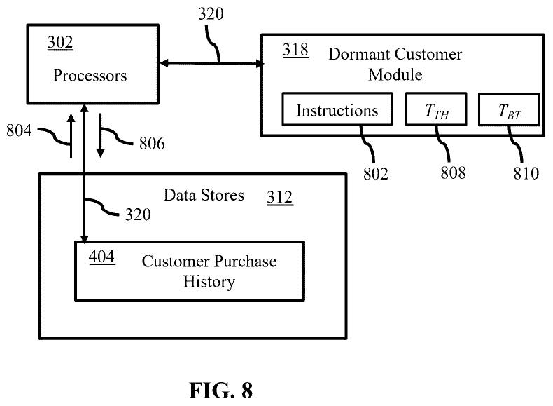

FIG. 8 illustrates a block diagram of one or more processors 302, customer purchase history storage 404 within data stores 312 and dormant customer module 318 for classifying a customer as viable or non-viable in accordance with aspects of the present disclosure. Dormant customer module 318 includes instructions 802, the value of the predetermined threshold of time T_{TH} indicated as data item 808, and the value of the predetermined threshold of time T_{BT} indicated as data item 810, stored therein.

In one or more embodiments, one or more processors 302 may execute instructions 802 in dormant customer module 318 to cause one or more enterprise servers 104 to store the values of T_{TH} and T_{BT} in dormant customer module 318. In one or more embodiments, one or more processors 302 may execute instructions in dormant customer module 318 to cause one or more enterprise servers 104 to modify the values of at least one of T_{TH} and T_{BT}.

In operation, when evaluating a customer as being viable or non-viable, one or more processors 302 execute instructions 802 to cause one or more processors to obtain data 804 from customer purchase history data storage 404, wherein the data indicates how long the customer has been a customer and dates of any breaches of terms by the customer. One or more processors 302 then execute instructions 802 to cause one or more processors to compare data 804 with data item 808 and data item 810 to determine whether the customer is viable or non-viable. One or more processors 302 then execute instructions 802 to cause one or more processors to send a classification instruction 806 to modify the customer data within customer purchase history so as to label the customer as viable or non-viable.

As mentioned above, an aspect of the present disclosure is to determine which current customers have, in the recent past, been purchasing and using the credit offered by enterprise 600, but have recently become “dormant,” wherein their purchase amounts and/or purchase numbers have greatly decreased. If dormant, in accordance with aspects of the present disclosure, enterprise 600 may offer promotions to such customers in order to spur further use of the available credit. However, enterprise 600 may not be willing to offer such promotions to customers who are relatively new, or have missed or made late payments in the recent past. For this reason, enterprise 600 may weed out such customers to create a pool of “viable” customers, or those that would more likely provide a benefit to enterprise 600 with a new promotion.

Returning to FIG. 5, if it is determined that the customer is not viable (N at S506), then a time period passes (S508). For example, returning to FIG. 3, one or more processors 302 may execute instructions in dormant customer module 318 to cause one or more enterprise servers 104 to wait a predetermined period of time T_{W}.

Although a customer may not have been a customer sufficiently long to surpass T_{TH}, as discussed above, that time period will eventually change. For this reason, it is beneficial to repeatedly check the status of customers to increase the pool of viable customers. Similarly, a customer may have had a breech in at least one term of enterprise 600 that is within the predetermined threshold of time T_{BT}. However, if that customer does not commit any further breaches, they will sufficiently pass the predetermined threshold of time T_{BT}.

In one or more embodiments, one or more processors 302 may execute instructions in dormant customer module 318 to cause one or more enterprise servers 104 to store the value of T_{W} in dormant customer module 318. In one or more embodiments, one or more processors 302 may execute instructions in dormant customer module 318 to cause one or more enterprise servers 104 to modify the value of T_{W}.

Returning to FIG. 5, after a time period passes (S508), customer data is updated (S510). For example, returning to FIGS. 3 and 4, one or more processors 302 may execute instructions in dormant customer module 318 to cause one or more enterprise servers 104 to update customer data in customer data storage 402.

In one or more embodiments, one or more processors 302 may execute instructions in dormant customer module 318 to cause one or more enterprise servers 104 to update the time for which each customer has been a customer in customer data storage 402. Further, in one or more embodiments, one or more processors 302 may execute instructions in dormant customer module 318 to cause one or more enterprise servers 104 to update the time for which each customer has breached at least one term of enterprise 600. With this in mind, in one or more embodiments, one or more processors 302 may execute instructions in dormant customer module 318 to cause one or more enterprise servers 104 to additionally update customer data for any customer that has breached at least one term of enterprise 600 within predetermined time period T_{W}.

Returning to FIG. 5, after customer data is updated (S510), it is determined whether the customer is viable (Return to S506). Alternatively, if it is determined that the customer is viable (Y at S506), then the customer is classified (S512). For example, returning to FIG. 3, one or more processors 302 may execute instructions in dormant customer module 318 to cause one or more enterprise servers 104 to classify the customer.

In accordance with aspects of the present disclosure, a viable customer may be classified as active or dormant based on purchase history.

In one or more embodiments, if a viable customer's purchase history is less than a predetermined purchase threshold P_{TH}, then the viable customer will be classified as a dormant customer, whereas if the viable customer's purchase history is equal to or greater than the predetermined purchase threshold P_{TH}, then the viable customer will be classified as an active customer.

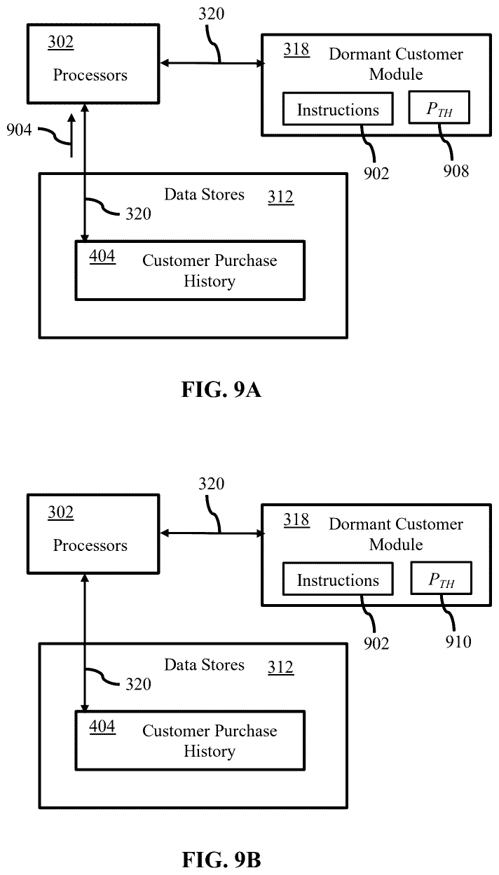

In one or more embodiments, PTH may be predetermined based on an analysis of customer purchase history of a plurality of customers. This will be described in greater detail with reference to FIGS. 9A-B.

FIG. 9A illustrates a block diagram of a portion of one or more enterprise servers 104 for determining a purchase threshold PTH at a time t0 in accordance with aspects of the present disclosure.

As shown in the figure, dormant customer module 318 includes instructions 902 and a purchase threshold P_{TH}, indicated as data item 908, stored therein. In one or more embodiments, purchase threshold P_{TH} is determined via a generative pre-trained ML algorithm that has evaluated one or more properties of a plurality of customer purchase history training functions to establish P_{TH} so as to maximize the likelihood of determining at what point in time, that a viable customer becomes a dormant customer.

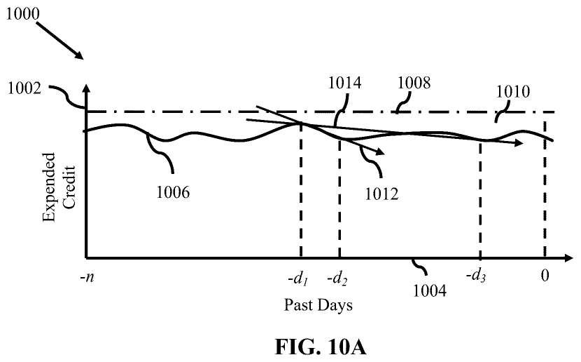

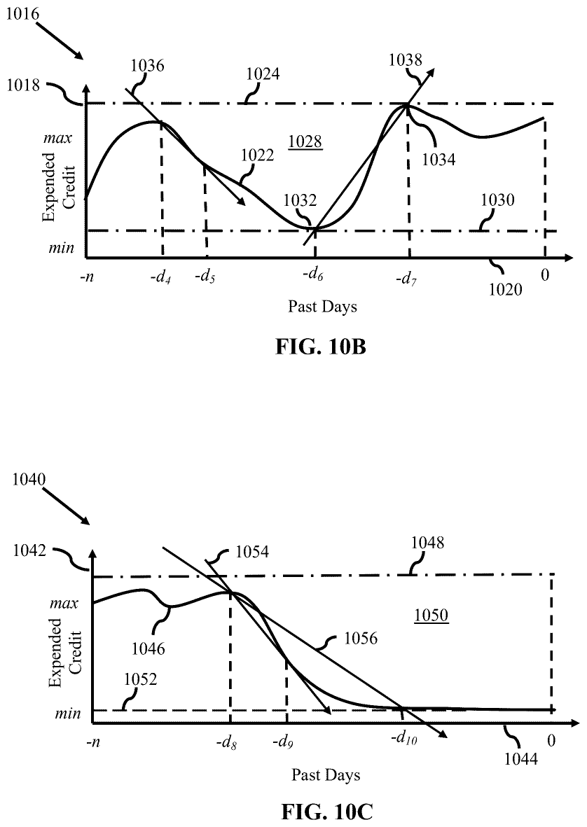

In one or more embodiments, one or more processors 302 may access current customer purchase history data 904 to generatively train the generative pre-trained ML algorithm by evaluating the same one or more properties of at least one customer purchase history data of a corresponding at least one current customer from customer purchase history storage 404 to update P_{TH} so as to maximize the likelihood of determining at what point in time, that a viable customer becomes a dormant customer. This will be described in greater detail with reference to FIGS. 10A-C.

FIG. 10A illustrates a graph 1000 of example customer purchase history of an example first viable customer of enterprise 600 up to the present. As shown in the figure, graph 1000 includes a y-axis 1002, an x-axis 1004, and a function 1006. Y-axis 1002 corresponds to expended credit by the first viable customer, whereas x-axis 1004 corresponds to past days.

Function 1006 corresponds to the expended credit by the first viable customer from a number n days to a present day, i.e., [−n days, 0 days]. Here, expended credit includes purchases toward a credit card minus payments on the credit card.

For purposes of discussion only, let plot 1006 correspond to an amount of expended credit per day for the first viable customer. Further, let the first viable customer have a credit limit, as provided by enterprise 600, as indicated by dashed-dotted line 1008. Let an area 1010 between dashed-dotted line 1008 and function 1006 represent credit that is not being used by the first viable customer. On average, as shown in the figure, the first viable customer is using a large percentage of the credit offered by enterprise 600, which is beneficial to enterprise 600.

Returning to FIG. 9A, in one or more embodiments, one or more processors 302 may execute instructions 902 to evaluate one or more properties of function 1006 to establish PTH, non-limiting examples of which include a single gradient as measured between predetermined time periods between day −n and the present day, a sum of a plurality of gradients as measured between a respective plurality of predetermined time periods between day −n and the present day, an average of a plurality of gradients as measured between a respective plurality of predetermined time periods between day-n and the present day, a single gradient as measured between predetermined time periods within a predetermined window of time between day −n and the present day, a sum of a plurality of gradients as measured between predetermined respective time periods within a predetermined window of time between day −n and the present day, an average of a plurality of gradients as measured between predetermined respective time periods within a predetermined window of time between day −n and the present day, a gradient as measured between predetermined time periods within a moving window of time having a predetermined size, a sum of a plurality of gradients as measured between predetermined respective time periods within a moving window of time having a predetermined size, an average of a plurality of gradients as measured between predetermined respective time periods within a moving window of time having a predetermined size, a global maximum value within a predetermined period of time between day −n and the present day, a global maximum value within a predetermined window of time between day −n and the present day, a global maximum value within a moving window of time between day −n and the present day and having a predetermined size, a number of local maximum values within a predetermined period of time between day −n and the present day, a number of local maximum values within a predetermined window of time between day −n and the present day, a number of local maximum values within a moving window of time between day −n and the present day and having a predetermined size, a global minimum value within a predetermined period of time between day −n and the present day, a global minimum value within a predetermined window of time between day −n and the present day, a global minimum value within a moving window of time between day −n and the present day and having a predetermined size, a number of local minimum values within a predetermined period of time between day −n and the present day, a number of local minimum values within a predetermined window of time between day −n and the present day, a number of local minimum values within a moving window of time between day −n and the present day and having a predetermined size, a global maximum difference between the credit limit and expended credit within a predetermined period of time between day −n and the present day, a global maximum difference between the credit limit and expended credit within a predetermined window of time between day −n and the present day, a global maximum difference between the credit limit and expended credit within a moving window of time between day −n and the present day and having a predetermined size, a number of local maximum differences between the credit limit and expended credit within a predetermined period of time between day −n and the present day, a number of local maximum differences between the credit limit and expended credit within a predetermined window of time between day −n and the present day, a number of local maximum differences between the credit limit and expended credit within a moving window of time between day −n and the present day and having a predetermined size, a global minimum difference between the credit limit and expended credit within a predetermined period of time between day −n and the present day, a global minimum difference between the credit limit and expended credit within a predetermined window of time between day −n and the present day, a global minimum difference between the credit limit and expended credit within a moving window of time between day −n and the present day and having a predetermined size, a number of local minimum differences between the credit limit and expended credit within a predetermined period of time between day −n and the present day, a number of local minimum differences between the credit limit and expended credit within a predetermined window of time between day −n and the present day, a number of local minimum differences between the credit limit and expended credit within a moving window of time between day −n and the present day and having a predetermined size, and combinations thereof.

In one or more embodiments, one or more processors 302 may execute instructions 902 to evaluate one or more properties of function 1006 via a pre-trained ML algorithm to establish a P_{TH} that will maximize the likelihood of determining at what point in time from day −n to the present, that the first viable customer becomes a dormant customer. The properties of function 1006 that are used in such an analysis, would be the same properties of functions that were used as training data to train the generative pre-trained ML algorithm.

For purposes of discussion only, for example, in one or more embodiments, one or more processors 302 may execute instructions 902 to evaluate a gradient 1012 of function 1006 as measured between a day −d1 and a day −d2. In one or more other embodiments, one or more processors 302 may execute instructions 902 to evaluate a gradient 1014 of function 1006 as measured between a day −d1 and a day −d3. In one or more other embodiments, one or more processors 302 may execute instructions 902 to evaluate both gradient 1012 and gradient 1014.

FIG. 10B illustrates a graph 1016 of example customer purchase history of an example second viable customer of enterprise 600 up to the present. As shown in the figure, graph 1016 includes a y-axis 1018, an x-axis 1020, and a function 1022. Y-axis 1018 corresponds to expended credit by the second viable customer, whereas x-axis 1020 corresponds to past days.

Function 1022 corresponds to the expended credit by the second viable customer from a number n days to a present day, i.e., [−n days, 0 days]. Here, expended credit includes purchases toward a credit card minus payments on the credit card.

For purposes of discussion only, let function 1022 correspond to an amount of expended credit per day for the second viable customer. Further, let the second viable customer have a credit limit, as provided by enterprise 600, as indicated by dashed-dotted line 1024. Let an area 1028 between dashed-dotted line 1024 and function 1022 represent credit that is not being used by the second viable customer.

As compared to that of the first viable customer as discussed above with reference to FIG. 10A, the second viable customer uses much less of the credit offered by enterprise 600 overall, which is less beneficial to enterprise 600. Further, as compared to that of the first viable customer as discussed above with reference to FIG. 10A, the second viable customer uses the available credit in a much less consistent manner. In particular, as evidenced by a minimum expended credit amount, wherein at a day −d6, function 1022 meets a dashed-dotted line 1030 at a point 1032, and as evidenced that by a day −d7, the second viable customer has maxed out the available credit as shown by function 1022 meeting dashed-dotted line 1024 at point 1034.

It would be more beneficial to reallocate credit that is not used by the second viable customer to another customer that will use the credit. However, in conventional methods, enterprises are unable to predict when to reallocate credit from one viable customer to another viable customer as evidenced by the drastic variations in credit use shown by the second viable customer in function 1022.

Returning to FIG. 9A, in one or more embodiments, one or more processors 302 may execute instructions 902 to evaluate one or more properties of function 1022. For purposes of discussion only, for example, in one or more embodiments, one or more processors 302 may execute instructions 902 to evaluate a gradient 1036 of function 1022 as measured between a day −d₄ and a day −d₅. In one or more other embodiments, one or more processors 302 may execute instructions 902 to evaluate a gradient 1038 of function 1022 as measured between a day −d₆ and day −d₇. In one or more other embodiments, one or more processors 302 may execute instructions 902 to evaluate both gradient 1036 and gradient 1038.

FIG. 10C illustrates a graph 1040 of example customer purchase history of an example third viable customer of enterprise 600 up to the present. As shown in the figure, graph 1040 includes a y-axis 1042, an x-axis 1044, and a function 1046. Y-axis 1042 corresponds to expended credit by the third viable customer, whereas x-axis 1044 corresponds to past days.

Function 1046 corresponds to the expended credit by the third viable customer from a number n days to a present day, i.e., [−n days, 0 days]. Here, expended credit includes purchases toward a credit card minus payments on the credit card.

For purposes of discussion only, let function 1046 correspond to an amount of expended credit per day for the third viable customer. Further, let the third viable customer have a credit limit, as provided by enterprise 600, as indicated by dashed-dotted line 1048. Let an area 1050 between dashed-dotted line 1048 and function 1046 represent credit that is not being used by the third viable customer.

As compared to that of the first viable customer and second viable customer as discussed above with reference to FIGS. 10A-B, the third viable customer's use of the credit offered by enterprise 600 drops drastically, from a day −d8 to a minimum indicated by a dashed line 1052 at a day −d10, and does not increase thereafter.

It would be more beneficial to reallocate credit that is not used by the third viable customer to another customer that will use the credit. However, as mentioned above, in conventional methods, enterprises are unable to predict when to reallocate credit from one viable customer to another viable customer as evidenced by the drastic variations in credit use shown by the second viable customer in function 1022. In the case of the third viable customer, it is possible that the customer might at some future day again increase their expended credit. Unfortunately, for every day that this customer does not increase their expended credit, enterprise 600 has a loss of opportunity to make profit by reallocating such unexpended credit to another viable customer.

Returning to FIG. 9A, in one or more embodiments, one or more processors 302 may execute instructions 902 to evaluate one or more properties of function 1046. For purposes of discussion only, for example, in one or more embodiments, one or more processors 302 may execute instructions 902 to evaluate a gradient 1054 of function 1046 as measured between a day −d₈ and a day −d₉. In one or more other embodiments, one or more processors 302 may execute instructions 902 to evaluate a gradient 1056 of function 1046 as measured between a day −d₈ and day −d₁₀. In one or more other embodiments, one or more processors 302 may execute instructions 902 to evaluate both gradient 1054 and gradient 1056.

Again, in one or more embodiments, one or more processors 302 may execute instructions 902 to evaluate one or more properties of one or more customer purchase histories to update P_{TH}.

FIG. 9B illustrates the block diagram of FIG. 9A at a time t₁ in accordance with aspects of the present disclosure. As shown in the figure, one or more processors 302 may execute instructions 902 to update P_{TH}, indicated as data item 910, based on the evaluation as discussed above.

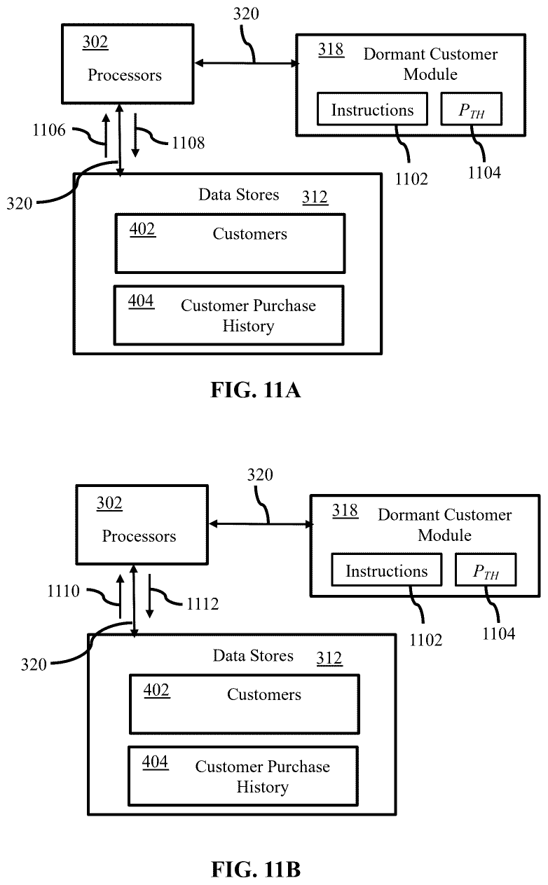

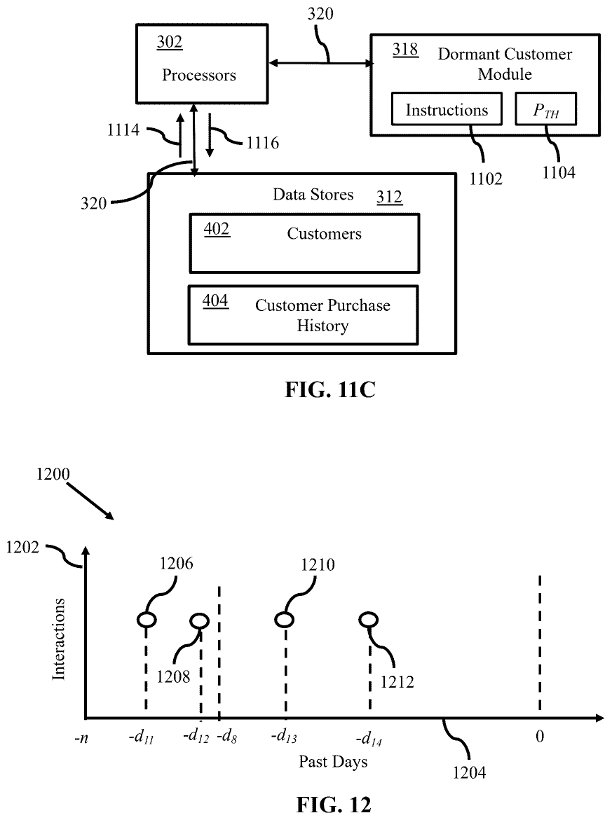

Once P_{TH} is updated, in one or more embodiments, one or more processors 302 may execute instructions in dormant customer module 318 to cause one or more processors 302 to evaluate purchase history data of each viable customer to classify each customer as active or dormant. This will be described in greater detail with reference to FIGS. 11A-C.

FIG. 11A illustrates a block diagram of a portion of one or more enterprise servers of FIG. 3 for classifying the first customer as active or dormant in accordance with aspects of the present disclosure.

As shown in FIG. 11A, dormant customer module 318 includes instructions 1102 and updated purchase threshold P_{TH} indicated as data item 910.

In one or more embodiments, one or more processors 302 may execute instructions 1102 to cause one or more processors 302 to obtain purchase history data of the first customer corresponding to function 1006 of FIG. 10A, from customer purchase history storage 404 as indicated by arrow 1106.

In one or more embodiments, one or more processors 302 may execute instructions 1102 to cause one or more processors 302 to compare values of one or more properties of function 1006 with P_{TH}. The properties of function 1006 that are used in such a comparison, would be the same properties of functions that were used to train the generative pre-trained ML algorithm.

For purposes of discussion only, returning to FIG. 10A, let the purchase threshold P_{TH} be determined based on a gradient between days −d₁ and −d₂. In such a scenario, one or more processors 302 may execute instructions 1102 to cause one or more processors 302 to compare gradient 1012 of function 1006 with P_{TH}. In one or more embodiments, in this scenario, one or more processors 302 may execute instructions 1102 to cause one or more processor 302 to classify the first customer as active if gradient 1012 is equal to or greater than P_{TH} and classify the first customer as dormant if gradient 1012 is less than P_{TH}. In one or more embodiments, in this scenario, one or more processors 302 may execute instructions 1102 to cause one or more processors 302 to transmit a classification instruction 1108 to customer purchase history storage 404 to cause customers storage to modify data of the first customer with a corresponding identification of active or dormant. For purposes of discussion only, in this example, let the first customer be flagged as active.

FIG. 11B illustrates a block diagram of a portion of one or more enterprise servers of FIG. 3 for classifying the second customer as active or dormant in accordance with aspects of the present disclosure.

In one or more embodiments, one or more processors 302 may execute instructions 1102 to cause one or more processors 302 to obtain purchase history data of the second customer corresponding to function 1022 of FIG. 10B, from customer purchase history storage 404 as indicated by arrow 1110.

In one or more embodiments, one or more processors 302 may execute instructions 1102 to cause one or more processors 302 to compare values of one or more properties of function 1022 with P_{TH}. The properties of function 1022 that are used in such a comparison, would be the same properties of functions that were used to train the generative pre-trained ML algorithm.

For purposes of discussion only, returning to FIG. 10B, let the purchase threshold P_{TH} be determined based on an average of a gradient between days −d₄ and −d₅ and a gradient between days −d₆ and −d₇. In such a scenario, one or more processors 302 may execute instructions 1102 to cause one or more processors 302 to compare an average of gradient 1036 and gradient 1038 of function 1022 with P_{TH}. In one or more embodiments, in this scenario, one or more processors 302 may execute instructions 1102 to cause one or more processor 302 to classify the second customer as active if the average of gradient 1036 and gradient 1038 is equal to or greater than P_{TH} and classify the second customer as dormant if the average of gradient 1036 and gradient 1038 is less than P_{TH}. In one or more embodiments, in this scenario, one or more processors 302 may execute instructions 1102 to cause one or more processors 302 to transmit a classification instruction 1112 to customer purchase history storage 404 to cause customers storage to modify data of the second customer with a corresponding identification of active or dormant. For purposes of discussion only, in this example, let the second customer be flagged as active.

FIG. 11C illustrates a block diagram of a portion of one or more enterprise servers of FIG. 3 for classifying the third customer as active or dormant in accordance with aspects of the present disclosure.

In one or more embodiments, one or more processors 302 may execute instructions 1102 to cause one or more processors 302 to obtain purchase history data of the third customer corresponding to function 1046 of FIG. 10C, from customer purchase history storage 404 as indicated by arrow 1114.

In one or more embodiments, one or more processors 302 may execute instructions 1102 to cause one or more processors 302 to compare values of one or more properties of function 1046 with P_{TH}. The properties of function 1046 that are used in such a comparison, would be the same properties of functions that were used to train the generative pre-trained ML algorithm.

For purposes of discussion only, returning to FIG. 10C, let the purchase threshold P_{TH} be determined based on a global maximum between days −d₉ and the present day. In such a scenario, one or more processors 302 may execute instructions 1102 to cause one or more processors 302 to compare the global maximum of function 1046 between day −d₉ and the present day with P_{TH}. In one or more embodiments, in this scenario, one or more processors 302 may execute instructions 1102 to cause one or more processor 302 to classify the third customer as active if the global maximum of function 1046 between day −d₉ and the present day is equal to or greater than P_{TH} and classify the third customer as dormant if the global maximum of function 1046 between day −d₉ and the present day is less than P_{TH}. In one or more embodiments, in this scenario, one or more processors 302 may execute instructions 1102 to cause one or more processors 302 to transmit a classification instruction 1116 to customer purchase history storage 404 to cause customers storage to modify data of the third customer with a corresponding identification of active or dormant. For purposes of discussion only, in this example, let the third customer be flagged as dormant.

Returning to FIG. 5, after the customer is classified (S512), it is determined whether the customer is active (S514). For example, returning to FIGS. 3 and 4, one or more processors 302 may execute instructions in dormant customer module 318 to cause one or more enterprise servers 104 to determine whether the customer is active.

In one or more embodiments, one or more processors 302 may execute instructions in dormant customer module 318 to cause one or more enterprise servers 104 to access data of the customer within customers storage 402 to determine whether the customer has been previously classified as active or dormant.

Returning to FIG. 5, if it is determined that the customer is active (Y at S514), then a time period passes (Return to S508). However, if it is determined that the customer is dormant (N at S514) then it is determined whether a customer engagement event is identified (S516). For example, returning to FIG. 3, one or more processors 302 may execute instructions in dormant customer module 318 to cause one or more enterprise servers 104 to determine whether a customer engagement event is identified.

In some cases, customers may engage with enterprise 600. Such engagements include a direct enterprise customer representative initiated phone call, an automated enterprise initiated phone call, a direct customer initiated phone call, a direct enterprise customer representative initiated email, an automated enterprise initiated email, and a direct customer initiated email. Any of these engagement are termed an engagement event. Further, one or more processors 302 may execute instructions in dormant customer module 318 to cause one or more enterprise servers 104 to store engagement event data for each corresponding engagement event in customer engagements storage 406. In one or more embodiments, engagement event data for each customer includes at least one of an engagement event date of each engagement event; notes related to each engagement event; and customer survey information related to each engagement event.

FIG. 12 illustrates a discrete plot 1200 of interactions of the third customer corresponding to function 1046 of FIG. 10C up to the present. As shown in the figure, discrete plot 1200 includes a y-axis 1202, an x-axis 2004, and engagement events 1206, 1208, 1210 and 1212. Y-axis 1202 corresponds to engagement events, whereas x-axis 1204 corresponds to past days.

By viewing the location of day −d₈ within discrete plot 1200, it is clear that day −d₈ is after engagement event 1208. As such, it is possible that an explanation for the decrease in purchases by the third customer corresponding to plot function 1046 as discussed above with reference to FIG. 10C, is related to engagement event 1208.

For example, and for purposes of explanation only, let engagement event 1206 be a customer initiated phone call to a representative within enterprise 600, wherein the purpose of the customer initiated phone call was to request a replacement credit card as a result of the third customer's original credit card being stolen. To continue this example, suppose that the third customer does not receive the credit card, which prompts engagement event 1208. Let engagement event 1208 again be a customer initiated phone call to a representative within enterprise 600, wherein the purpose of the customer initiated phone call was to again request a replacement credit card as a result of the third customer's original credit card being stolen. For purposes of this discussion, let the third customer have credentials of the credit card available on their smartphone, computer, and/or phone or web applications. Even though they might not need an actual credit card, the third customer may feel slighted that their request was not promptly fulfilled. At this point, the third customer may be frustrated and stop using the credit card, which is reflected in the decrease in purchases as shown in function 1046 of FIG. 10C.

In this scenario, one or more processors 302 may execute instructions in dormant customer module 318 to cause one or more enterprise servers 104 to evaluate customer engagement event data within customer engagements storage 406 in conjunction with customer purchase history within customer purchase history storage 404 to identify an engagement event that may be related to a decrease in purchases.

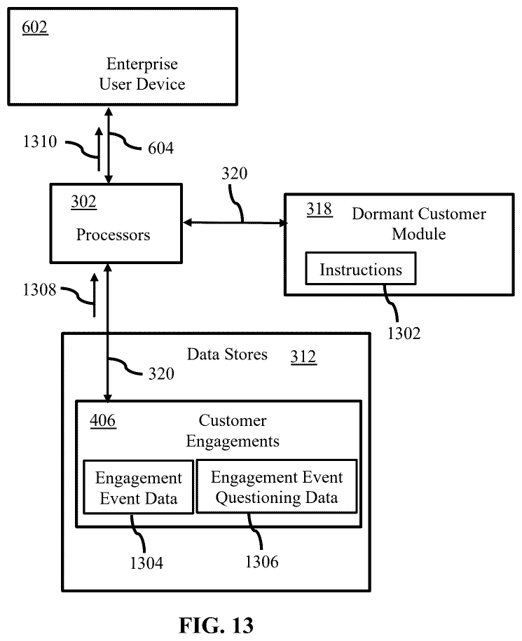

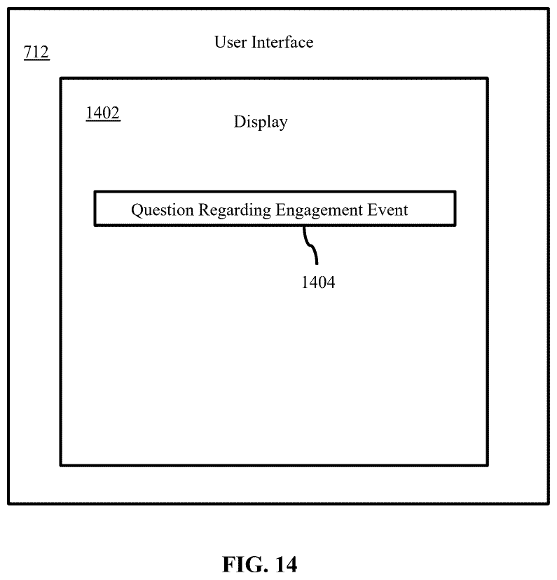

Returning to FIG. 5, if it is determined that a customer engagement event is identified (Y at S516) then a customer engagement event message is generated (S518). For example, returning to FIG. 3, one or more processors 302 may execute instructions in dormant customer module 318 to cause one or more enterprise servers 104 to generate a customer engagement event message. This will be described in greater detail with reference to FIGS. 13-14.

FIG. 13 illustrates a block diagram of a portion of one or more enterprise servers of FIG. 3 and enterprise user device 602 for displaying information related to a predetermined question regarding an engagement event in accordance with aspects of the present disclosure.

As shown in FIG. 13, dormant customer module 318 includes instructions 1302, whereas customer engagements storage 406 includes engagement event data 1304 and engagement event questioning data 1306 stored therein.

In one or more embodiments, engagement event data 1304 includes, for each customer, at least one of: an engagement event date of each engagement event; notes related to each engagement event; and customer survey information related to each engagement event.

In one or more embodiments, engagement event questioning data 1306 includes a data structure corresponding to predetermined questions intended to be asked by an employee of enterprise 600 to a customer, wherein the predetermined questions relate to engagement event of the customer.

One or more processors 302 may execute instructions 1302 to cause one or more one or more processors 302 to access engagement event data 1308 related to the customer from engagement event data 1304 within customer engagements storage 406, and to access engagement event questioning data 1306. One or more processors 302 may execute instructions 1302 to cause one or more one or more processors 302 to analyze engagement event data 1308 related to the customer, for example, in a manner as discussed above with reference to FIGS. 10C and 12. One or more processors 302 may execute instructions 1302 to cause one or more one or more processors 302 to generate a predetermined question signal 1310 based on customer engagement event questioning data 1306 and the customer engagement event data 1308.

Upon receiving predetermined question signal 1310, enterprise user device 602 is configured to display information related to the predetermined question regarding the customer engagement event. For example, returning to FIG. 7, upon receiving predetermined question signal 1310, system controller 702 may executed instructions within customer program 706 to cause UI 712 to display to display information related to the predetermined question regarding the customer engagement event. This will be described in greater detail with reference to FIG. 14.

FIG. 14 illustrates UI 712 of enterprise user device 602 displaying a predetermined question regarding an engagement event in accordance with aspects of the present disclosure. As shown in the figure, UI 712 includes a display 1402 displaying a predetermined question 1404 regarding an engagement event.

Further, in one or more embodiments, predetermined question signal 1310 may have a fillable data field that may be filled by information related to an identified engagement event as discussed above (See S516). For example, predetermined question signal 1310 may cause system controller 702 to executed instruction within customer program 706 to cause UI 712 to display a question “Were you at all dissatisfied with your ______ with our bank on ______?”, wherein the first blank may be filled in with one of “phone call” or “email,” whereas the second blank may be filled in with a date of the identified engagement event.

For purposes of explanation, consider the situation wherein a customer calls enterprise 600 to speak with a representative. Further, let the representative be using enterprise user device 602. Still further, let this customer be the third customer corresponding to function 1046 of FIG. 10C. Upon speaking with the third customer, and with reference to FIGS. 4, 6 and 7, the representative may access information of the third customer from any one of customer data storage 402, customer purchase history storage 404, customer engagements storage 406 or promotions storage 408 via UI 712 of enterprise user device 602.

Further, in one or more embodiments, dormant customer module 318 may have instructions stored therein, that when executed by one or more processors 302, one or more enterprise servers 104 to instruct user interface 712 of enterprise user device 602 to display a message for the representative, “Were you at all dissatisfied with your ______ with our bank on ______?”, wherein the first blank is filled in with a respective one of “phone call” or “email,” and the second blank may be filled in with the date of the identified engagement event, as provided by information in customer engagements storage 406.

In this manner, the representative may be more able to address any issues that the third customer encountered from enterprise 600, which led to a decrease in purchases. Therefore, the representative may be able to return the third customer to a purchasing amount that was similar to that prior the engagement event that sparked to purchasing amount decrease. As such, by displaying to the representative information related to the predetermined question regarding the event, the representative may be able to convert the currently dormant third customer to an active third customer.

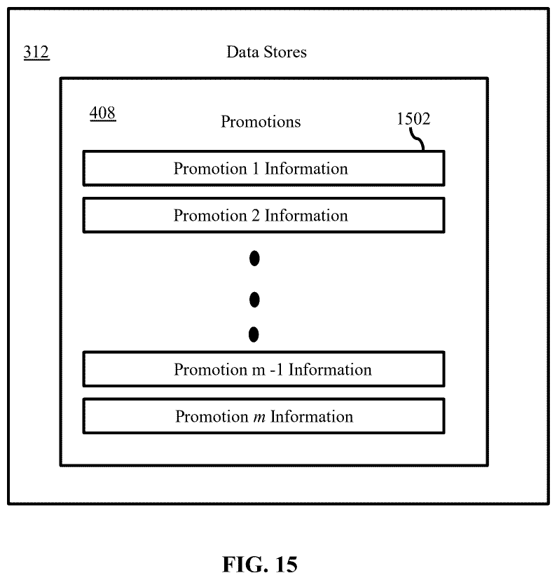

Returning to FIG. 5, if it is determined that a customer engagement event is not identified (N at S516) or after a customer engagement event is generated (S518), a promotion message is generated (S520). For example, returning to FIG. 3, For example, returning to FIG. 3, one or more processors 302 may execute instructions in dormant customer module 318 to cause one or more enterprise servers 104 to generate a promotion message. This will be described in greater detail with reference to FIGS. 15-17.

In one or more embodiments, promotions storage 408 may have promotion data stored therein. In a non-limiting example, the promotion data may include instructions, that when executed by one or more processors 302, cause one or more enterprise servers 104 to generate a predetermined promotion to be offered to a customer by an employee of enterprise 600.

FIG. 15 illustrates the promotions data storage displaying available promotions in accordance with aspects of the present disclosure.

As shown in FIG. 15, promotions storage 408 includes a plurality of available promotion data structures stored therein, a sample of which is indicated as available promotion data structure 1502. Each available promotion data structure includes, respective data related to each respective available promotion, non-limiting examples of which include an introductory rate, an introductory time windows, a standard rate, a transfer rate, a change in credit limit, and combinations thereof.

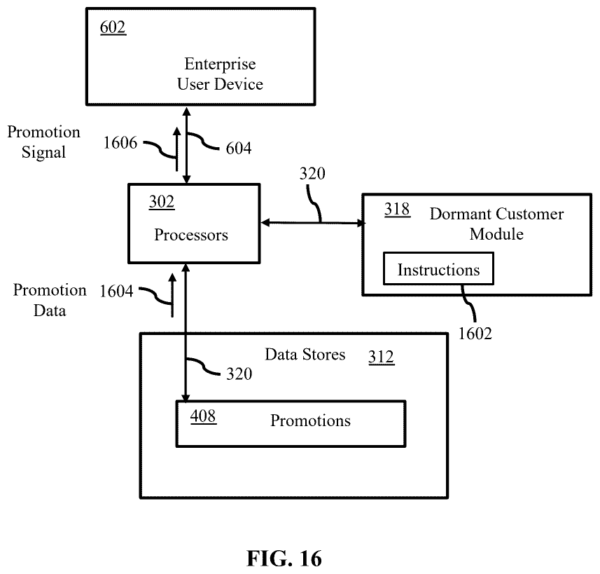

FIG. 16 illustrates a block diagram of a portion of one or more enterprise servers of FIG. 3 and enterprise user device 602 for displaying information related to an available promotion in accordance with aspects of the present disclosure.

As shown in FIG. 16, dormant customer module 318 includes instructions 1602 stored therein.

One or more processors 302 may execute instructions 1602 to cause one or more one or more processors 302 to access one or more available promotion data structures 1604 from the plurality of available promotion data structures stored within promotions storage 408. One or more processors 302 may execute instructions 1602 to cause one or more one or more processors 302 to generate an available promotion signal 1606 based on one or more available promotion data structures 1604.

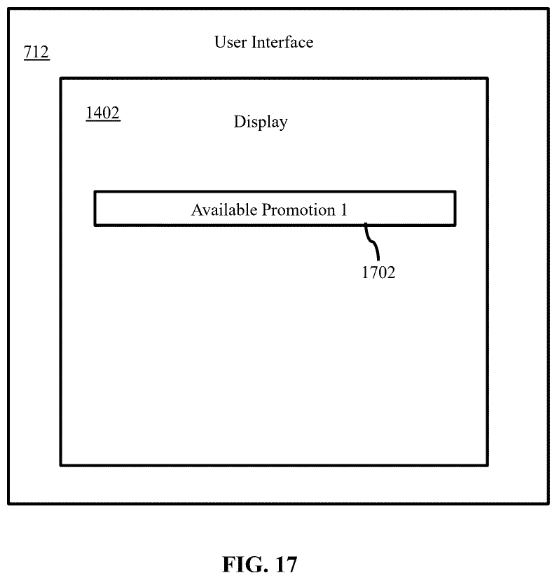

Upon receiving available promotion signal 1606, enterprise user device 602 is configured to display information related to one or more available promotions. For example, returning to FIG. 7, upon receiving available promotion signal 1606, system controller 702 may executed instructions within customer program 706 to cause UI 712 to display to display information related to one or more available promotions. This will be described in greater detail with reference to FIG. 17.

FIG. 17 illustrates UI 712 of enterprise user device 602 displaying a predetermined available promotion in accordance with aspects of the present disclosure. As shown in the figure, UI 712 includes a display 1402 displaying a predetermined available promotion 1702.

For purposes of explanation, consider the situation wherein a customer calls enterprise 600 to speak with a representative. Further, let the representative be using enterprise user device 602. Still further, let this customer be the third customer corresponding to function 1046 of FIG. 10C. Upon speaking with the third customer, and with reference to FIGS. 4, 6 and 7, the representative may access information of the third customer from any one of customer data storage 402, customer purchase history storage 404, customer engagements storage 406 or promotions storage 408 via UI 712 of enterprise user device 602.

Further, in one or more embodiments, dormant customer module 318 may have instructions stored therein, that when executed by one or more processors 302, one or more enterprise servers 104 to instruct user interface 712 of enterprise user device 602 to display a message for the representative, “I'm pleased to inform you that you have been selected for our promotion ______, wherein ______”, wherein the first blank is filled in with a respective promotion title, and the second blank may be filled in with respective data related to each respective available promotion, non-limiting examples of which include an introductory rate, an introductory time windows, a standard rate, a transfer rate, a change in credit limit, and combinations thereof, as provided by an available promotion data structure in promotions storage 408.

In this manner, the representative may be more able to incentivize the third customer to return the third customer to a purchasing amount that was similar to that prior the engagement event that sparked to purchasing amount decrease. As such, by displaying to the representative information related to an available promotion, the representative may be able to convert the currently dormant third customer to an active third customer Returning to FIG. 5, after the promotion data is generated (S520), computer-implemented method 500 stops (S522).

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to enable others skilled in the art to best utilize the invention in various embodiments and with various modifications as are suited to the particular use contemplated. It is intended that the scope of the invention be defined by the claims appended hereto.

What is claimed is:

1. A system, comprising:
a display;
a memory having stored therein, customer purchase history data associated with a customer, a purchase threshold P_{TH}, promotion data relating to an available promotion, and executable instructions stored therein; and
a processor configured to execute the executable instructions to cause said system to perform operations including:
classifying the customer as an active customer when a feature of the customer purchase history data is equal to or greater than the purchase threshold P_{TH};
classifying the customer as a dormant customer when the feature of the customer purchase history data is less than the purchase threshold P_{TH};
generating an available promotion signal based on the promotion data; and
transmitting the available promotion signal to said display to cause said display to display information related to the available promotion.

2. The system of claim 1, wherein said processor is further configured to execute the executable instructions to additionally cause said system to perform operations including:
identifying a customer engagement event within the customer purchase history data associated with a maximum gradient change when the feature of the customer purchase history data is less than the purchase threshold P_{TH};
identifying a customer engagement event date associated with the customer engagement event; and
storing, into said memory, customer engagement event data associated with the customer engagement event, the customer engagement event data including the customer engagement event date.

3. The system of claim 2, wherein:
said memory additionally has stored therein, customer engagement event questioning data relating to a predetermined question regarding the customer engagement event, and
said processor is further configured to execute the executable instructions to additionally cause said system to perform operations including:
generating a predetermined question signal based on the customer engagement event questioning data and the customer engagement event data; and
transmitting the predetermined question signal to said display to cause said display to display information related to the predetermined question regarding the customer engagement event.

4. The system of claim 1, wherein:
said memory additionally has stored therein, a time threshold T_{TH} and customer time data associated with a time period of the customer, and
said processor is further configured to execute the executable instructions to additionally cause said system to perform operations including:
classifying the customer as a viable customer when the time period of the customer is equal to or greater than the time threshold T_{TH},
classifying the customer as a non-viable customer when the time period of the customer is less than the time threshold T_{TH},
classifying the customer as an active customer when a feature of the customer purchase history data is equal to or greater than the purchase threshold P_{TH}, and the customer is classified as a viable customer, and
classifying the customer as a dormant customer when the feature of the customer purchase history data is less than the purchase threshold P_{TH}, and the customer is classified as a viable customer.

5. The system of claim 1, wherein the purchase threshold P_{TH} is generated via a machine learning algorithm based on purchase history data of a plurality of customers.

6. The system of claim 5, wherein the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.

7. The system of claim 1, wherein:
said memory additionally has stored therein, customer contact information relating to one of a phone number associated with the customer, an email address associated with the customer, and combinations thereof, and
said processor is further configured to execute the executable instructions to additionally cause said system to perform operations including:
generating a customer contact information signal based on the customer contact information; and
transmitting the customer contact information signal to said display to cause said display to display information related to the customer contact information.

8. A computer-implemented method of operating a system, said computer-implemented method comprising:
classifying, via a processor configured to execute executable instructions stored within a memory additionally having stored therein, customer purchase history data associated with a customer, and a purchase threshold P_{TH}, promotion data relating to an available promotion, the customer as an active customer when a feature of the customer purchase history data is equal to or greater than the purchase threshold P_{TH};
classifying, via the processor, the customer as a dormant customer when the feature of the customer purchase history data is less than the purchase threshold P_{TH};
generating, via the processor, an available promotion signal based on the promotion data; and
transmitting, via the processor and to a display, the available promotion signal to cause the display to display information related to the available promotion.

9. The computer-implemented method of claim 8, further comprising:
identifying, via the processor, a customer engagement event within the customer purchase history data associated with a maximum gradient change when the feature of the customer purchase history data is less than the purchase threshold P_{TH};
identifying, via the processor, a customer engagement event date associated with the customer engagement event; and
storing, into said memory, customer engagement event data associated with the customer engagement event, the customer engagement event data including the customer engagement event date.

10. The computer-implemented method of claim 9, wherein the memory additionally has stored therein, customer engagement event questioning data relating to a predetermined question regarding the customer engagement event, and wherein the computer-implemented method further comprises:
generating, via the processor, a predetermined question signal based on the customer engagement event questioning data and the customer engagement event data; and
transmitting, via the processor and to the display, the predetermined question signal to cause the display to display information related to the predetermined question regarding the customer engagement event.

11. The computer-implemented method of claim 8, wherein the memory additionally has stored therein, a time threshold T_{TH} and customer time data associated with a time period of the customer, and wherein the computer-implemented method further comprises:
classifying, via the processor, the customer as a viable customer when the time period of the customer is equal to or greater than the time threshold T_{TH};
classifying, via the processor, the customer as a non-viable customer when the time period of the customer is less than the time threshold T_{TH};
classifying, via the processor, the customer as an active customer when a feature of the customer purchase history data is equal to or greater than the purchase threshold P_{TH}, and the customer is classified as a viable customer; and
classifying, via the processor, the customer as a dormant customer when the feature of the customer purchase history data is less than the purchase threshold P_{TH}, and the customer is classified as a viable customer.

12. The computer-implemented method of claim 8, wherein the purchase threshold P_{TH} is generated via a machine learning algorithm based on purchase history data of a plurality of customers.

13. The computer-implemented method of claim 12, wherein the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.

14. The computer-implemented method of claim 8, wherein the memory additionally has stored therein, customer contact information relating to one of a phone number associated with the customer, an email address associated with the customer, and combinations thereof, and wherein the computer-implemented method further comprises:
generating, via the processor, a customer contact information signal based on the customer contact information; and
transmitting, via the processor and to the display, the customer contact information signal to cause the display to display information related to the customer contact information.

15. A non-transitory, computer-readable media having computer-readable instructions stored thereon, the computer-readable instructions being capable of being read by system, wherein the computer-readable instructions are capable of instructing the system to perform a computer-implemented method comprising:
classifying, via a processor configured to execute executable instructions stored within a memory additionally having stored therein, customer purchase history data associated with a customer, and a purchase threshold P_{TH}, promotion data relating to an available promotion, the customer as an active customer when a feature of the customer purchase history data is equal to or greater than the purchase threshold P_{TH};
classifying, via the processor, the customer as a dormant customer when the feature of the customer purchase history data is less than the purchase threshold P_{TH};
generating, via the processor, an available promotion signal based on the promotion data; and
transmitting, via the processor and to a display, the available promotion signal to cause the display to display information related to the available promotion.

16. The non-transitory, computer-readable media of claim 15, wherein the computer-readable instructions are capable of instructing the system to perform the computer-implemented method further comprising:
identifying, via the processor, a customer engagement event within the customer purchase history data associated with a maximum gradient change when the feature of the customer purchase history data is less than the purchase threshold P_{TH};
identifying, via the processor, a customer engagement event date associated with the customer engagement event; and
storing, into said memory, customer engagement event data associated with the customer engagement event, the customer engagement event data including the customer engagement event date.

17. The non-transitory, computer-readable media of claim 16, wherein the memory additionally has stored therein, customer engagement event questioning data relating to a predetermined question regarding the customer engagement event, and wherein the computer-readable instructions are capable of instructing the system to perform the computer-implemented method further comprising:
generating, via the processor, a predetermined question signal based on the customer engagement event questioning data and the customer engagement event data; and
transmitting, via the processor and to the display, the predetermined question signal to cause the display to display information related to the predetermined question regarding the customer engagement event.

18. The non-transitory, computer-readable media of claim 15, wherein the memory additionally has stored therein, a time threshold T_{TH} and customer time data associated with a time period of the customer, and wherein the computer-readable instructions are capable of instructing the system to perform the computer-implemented method further comprising:
classifying, via the processor, the customer as a viable customer when the time period of the customer is equal to or greater than the time threshold T_{TH};
classifying, via the processor, the customer as a non-viable customer when the time period of the customer is less than the time threshold T_{TH};
classifying, via the processor, the customer as an active customer when a feature of the customer purchase history data is equal to or greater than the purchase threshold P_{TH}, and the customer is classified as a viable customer; and
classifying, via the processor, the customer as a dormant customer when the feature of the customer purchase history data is less than the purchase threshold P_{TH}, and the customer is classified as a viable customer.

19. The non-transitory, computer-readable media of claim 15, wherein the purchase threshold P_{TH} is generated via a machine learning algorithm based on purchase history data of a plurality of customers.

20. The non-transitory, computer-readable media of claim 19, wherein the purchase threshold P_{TH} is generated via a machine learning algorithm based on at least one of a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the purchase history data of the plurality of customers.
